(19) United States
(12) Patent Application Publication
(10) Pub. No.: US 2017/0278426 A1
(43) Pub. Date: Sep. 28, 2017

(54) Systems and methods for perceiving color-printed braille characters and predefined shapes by visually-impaired people

(71) Applicants: Tusher Chakraborty, Dhaka (BD); Taslim Arefin Khan, Dhaka (BD); A. B. M. Alim Al Islam, Dhaka (BD)

(72) Inventors: Tusher Chakraborty, Dhaka (BD); Taslim Arefin Khan, Dhaka (BD); A. B. M. Alim Al Islam, Dhaka (BD)

(21) Appl. No.: 15/079,316

(22) Filed: Mar. 24, 2016

(51) Int. Cl. G09B 21/00

(52) U.S. Cl. CPC G09B 21/008

(57) ABSTRACT

The subject matter disclosed herein relates to a method and design of a system that helps visually-impaired persons to identify Braille characters or geometric shapes such as rectangle, triangle, circle, etc. A Braille character is any combination of six dots that represents an alphanumeric character. The dot of Braille character is represented using a small colored region over a surface, which can be a paper. The color of dot is distinct from the color of surface. The system contains a coupling comprising a pair of light source and light sensor. The system enables recognizing printed Braille characters through identifying distinct colored dots of Braille characters, by sensing real-time deviation in illuminance of light reflected off the surface containing the printed Braille characters. The output of the system encompasses perceivable signal.

### FIELD OF THE INVENTION

The present invention relates to a method and design of a system that can recognize colored regions on a printed surface and produce signals worth of perceiving accordingly, and thereby enables visually-impaired persons to identify Braille characters or geometric shapes using a coupling comprising a light source and a light sensor.

### BACKGROUND OF THE INVENTION

World Health Organization (WHO) reports that about 285 million people are visually-impaired worldwide. Among them, 246 million people have low vision, and 39 million people are completely blind. To those visually-impaired people, reading and writing is a daunting task that poses a significant threat to their literacy. As a matter of fact, literacy gets severely hampered in any form of disability. However, surprisingly, people with visual impairment generally exhibit greater interest for literacy compared to people with other disabilities. Nonetheless, the state-of-the-art methods of education for visually-impaired persons do not promote them much in road to achieving their literacy. This happens as the methods are complex and equipments are generally expensive, for example the Braille embosser printer, and thus are mostly limited within the scope of financially solvent organizations. Consequently, the existing equipments are far from being ubiquitous for the visually-impaired people all over the world.

Braille encoded patterns are the most widely adopted, perceivable tactile writing system and medium of instruction intended for the visually-impaired people. Each Braille pattern consists of a six-dot pattern representing any of the alphanumeric characters. In general, visually-impaired people can read and sense Braille encoded patterns through tiny palpable bumps made either on a piece of paper being printed using Braille printers or on other surfaces such as metallic surfaces. Although Braille is the most prominent and most used medium of instruction for the visually-impaired people, contemporary Braille systems exhibits several drawbacks. The most important one among them is that specialized printers used for the Braille system are highly expensive. A number of schools and educational institutions around the world cannot afford such expensive Braille printers, let alone for personal uses by a visually-impaired individual. Moreover, writing in contemporary Braille system is a cumbersome process as it demands making palpable dots on a surface, which is difficult to do.

Tactile graphics are commonly used by visually-impaired people for sensing graphical images, maps, surfaces, etc. Tactile graphics are raised surfaces that allow a visually-impaired person to touch and feel shapes over different surfaces. Here, the person can get or perceive a general idea of a geographical object or map through feeling a shape. This form of representation is undoubtedly helpful. However, a major limitation of tactile graphic printers is that they are much costlier than Braille printers. Moreover, it cannot be adopted as a ubiquitous tool due to its limited portability, and most importantly, due to the fact that not all information can be represented using tactile graphics.

Talking e-books and radio reading services offer substantial liberty in terms of portability. Using these tools, a visually-impaired person can listen to programs or documents of own choice. However, these tools cannot offer writing services. Moreover, people constrained by limited financial capabilities cannot think of buying a talking e-book owing to their high expense.

Specialized softwares and tools are available for visually-impaired people so that they can operate computers and other personal gadgets. Using assistive softwares and tools, they can operate a computer and do regular work on a computer. However, these tools do not offer a method for writing. Alongside, these tools do not offer readability to any geometric shape. Nonetheless, these tools are also expensive.

Regular paper and document based work by a visually-impaired person is a forgone idea. It is imperative that these people are needed to be given access to regular paper and documenting tasks in order to make their livelihoods easier and compelling. In order to do that, a low-cost ubiquitous tool is necessary that can aid them in reading and writing to perform regular paper work.

### SUMMARY OF THE INVENTION

The above mentioned problems are tackled through using a system comprising an active sensing body. A coupling consisting of a light source and a light sensor, oriented in the same direction, is positioned at the tip of the active sensing body. The light source continuously radiates energy over the visible light spectrum, and the coupled light sensor generates signal according to the illuminance of the light incident upon it after being reflected from the surface under the tip of the active sensing body. As the illuminance of the reflected light varies depending on the colors of reflector region of the surface, the signal generated by the sensor also varies accordingly. A processing unit is connected with the sensor for detecting presence of printed regions of distinct colors (e.g., black) on the surface. This is done by comparing the signals generated by the sensor with predefined threshold value.

The surface can be of different forms. For example, the surface can be a paper, a metallic sheet, etc.

The output generated by the processing unit can be utilized in various forms. For example, the output can be used to generate an audio signal, or to exert pressure, or to generate vibration, etc.

A Braille character is a combination of six dots arranged in three rows and two columns for representing an alphanumeric character. In conventional books and systems, Braille characters are represented using palpable dots. A visually-impaired person reads a Braille character through perceiving the combination of the palpable dots arranged in two columns. However, in our system, Braille characters are printed using conventional ink-jet or laser printers. Here, the dots can be represented by any shape such as square, rectangle, circle, etc. These shapes can appear in any color that is different from the color of the surface upon which the dots are printed.

Our system also includes a trajectory guide board that should be attached over the printed surface. The trajectory is made by drilling holes through top to bottom along the thickness of a solid board such as a plastic board, an ebonite board, etc. The holes are shaped in such a way that their size fits the tip of the active sensing body. The trajectory board guides the path of movement of the tip over a printed surface, which needs to be attached beneath the board. The path of movement is defined in such a way that the dot(s) of a Braille character printed on the surface appear in certain relative position(s) on the path. The path is repeated in a similar manner for multiple Braille characters. As the tip of the active sensing body moves along the path, the processing unit generates output(s) based on presence of braille dot(s) under the tip.

This system helps a blind or visually-impaired person in reading a document. Here, the document can be a paper having Braille encoded characters printed using conventional ink-jet or laser printers. While reading such a document, the blind or visually-impaired person needs to set the trajectory board over the paper. The tip of the active sensing body is able to glide through the drilled holes of the trajectory board. Thus, the person perceives a Braille character by detecting the relative position(s) of the dot(s) printed on the paper through perceiving the output(s) generated by the system.

It is a basic necessity of literacy to be able to write in addition to read. In this system, it is possible to easily make any combination of a six dot, and thus allow us to write a Braille character easily. Consequently, the system enables writing Braille characters that represent any alphanumeric characters. The trajectory guide helps in writing Braille characters in the same way that it helps in reading. It can be made possible by using any regular custom-off-the-shelf hand writing tool such as a pencil or a marker pen. As mentioned above, the trajectory path is defined in such a way that the dot(s) of a Braille character printed on the paper appear in a certain relative position on the path. Consequently, a visually-impaired person can put a braille dot on the certain position of the paper through the hole of trajectory guide board by using the writing tool. Here, after writing a Braille character, the person can go back and read what has been written with the system to double check or revise the written character(s).

Additionally, it is possible to perceive a geometric shape by detecting the locus of the geometric shape printed on the paper. The mechanism is fairly straight-forward. The border of the geometric shape appears in a distinct color on the paper. The geometric shape can be recognized by following the locus of the geometric shape upon utilizing the output(s) generated by the system. Here, the geometric shape can be linear, circular, polygon, etc.

Access to education is a fundamental right. Visually-impaired people are special people for whom access to education has always been a challenging problem. Although visually-impaired children attend formal schools at primary levels, it has been observed that a significant number of them dropout in the later stages of the academic life. To note a few reasons, first, the state-of-the-art mechanism of reading and writing Braille characters is challenging to adopt and practice. The mechanism often leads to frustrations in the later stages of academic life. Second, as a child steps in to high school and college, (s)he faces a scarcity in supporting tools to carry on his/her education. This system has specifically addressed these education aspects pertinent to visually-impaired persons. Here, an active sensing body along with a trajectory guide board can be used as an assistive tool to support education in a way that has been never seen before. Using this system, an individual or an organization will no longer depend upon the conventional expensive and less-available Braille printing presses or tools. This system offers a novel way using which individuals or organizations can enable independent reading of Braille characters printed by generally available printers such as laser and ink-jet printers. Moreover, this system can help visually-impaired persons in writing through replacing the conventional cumbersome and difficult-to-use bore drill methods.

### BRIEF DESCRIPTION OF THE DRAWINGS

The system is illustrated in the way of a developed real system and its operations.

FIG. 1 presents a block diagram of the overall system operation and a flowchart of the underlying mechanism of the system.

FIG. 2 presents a drawing of the active sensing body.

FIG. 3 shows a drawing of Braille characters printed on a paper using conventional ink-jet or laser printers.

FIG. 4 shows the drawing of a trajectory guide board.

FIG. 5 shows a trajectory guide board attached over a paper containing printed Braille characters.

### DETAILED DESCRIPTION OF THE DRAWINGS

In the following description, we are going to explain the underlying construction, methodology, and detail operation of the system.

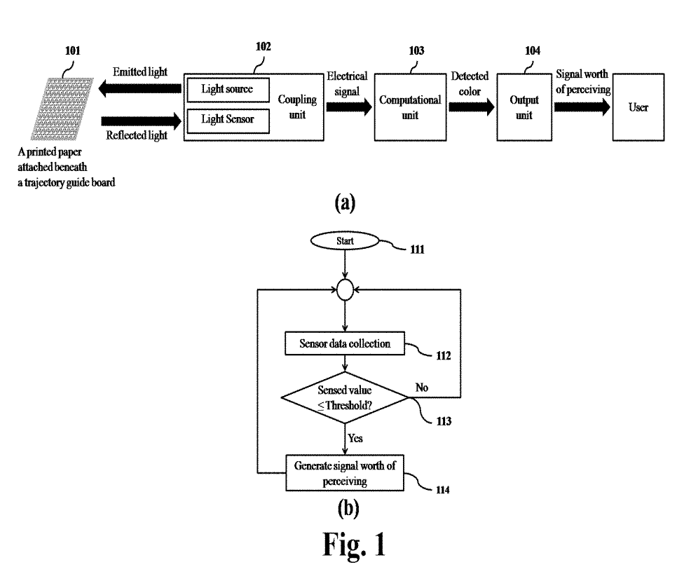

In FIG. 1(a), we present a simplified block diagram of the underlying operational mechanism of our system. The system consists of four units: (1) A paper with printed Braille characters and attached beneath a trajectory guide board 101, (2) A Coupling unit 102, (3) A Computational unit 103, and (4) An Output unit 104.

The Braille characters are printed on a paper using a conventional ink-jet or laser printer. A trajectory guide board is attached over the paper to help visually-impaired people in reading Braille characters printed on the paper through using a pen-shaped active sensing body. The pen-shaped active sensing body operates over the trajectory guide board attached over the paper containing printed Braille characters. To perform operation over this unit 101, the pen-shaped active sensing body utilizes its three units 102,103, and 104. Detail mechanism of reading process is explained later.

The Coupling unit 102 contains a pair of light source and light sensor, oriented in the same direction. The first task of the Coupling unit is to emit light, which gets incident upon the paper placed beneath the Coupling unit. The second task of the Coupling unit is to sense illuminance of the light reflected from the paper. The sensor generates signals according to the levels of illuminance of light incident upon it after being reflected from the paper. As the illuminance of reflected light varies depending on the colors of the reflector regions of the paper, the signals generated by the sensor also get varied.

The Computational unit 103 collects signals generated by light sensor of the Coupling unit. The Computational unit processes the collected signals for detecting presences of distinct colors on the paper over which the Coupling unit operates. Subsequently, the Output unit 104 generates audio output based on the detection made by the Computational unit. Examples of the Output unit include, but not limited to, headphone, earphone, etc.

FIG. 1(b) presents a flowchart of the underlying mechanism of the system. The mechanism consists of three sequential steps—sensor data collection, data processing, and output generation. At the very beginning, the system is powered on and the light sources generate light beams as shown in Step 111. In Step 112, the Computational unit collects data from the sensor. In the next step, i.e., in Step 113, the Computational unit compares the sensed value against a predefined threshold. If black color is printed on a white paper, the sensor generates a lower-valued signal when it is over the black colored region of paper compared to that when it is on the white colored region. Consequently, a threshold value is defined for distinguishing black colored region from the white colored region. Therefore, when the signal generated by the sensor is lower than or equal to threshold value, it indicates that the light incident upon the sensor is reflected from the black colored region. As a result, if the sensor value is lower than or equal to the threshold value, the output generation step, i.e., Step 114, generates audio output. Otherwise, the whole mechanism resumes from Step 112.

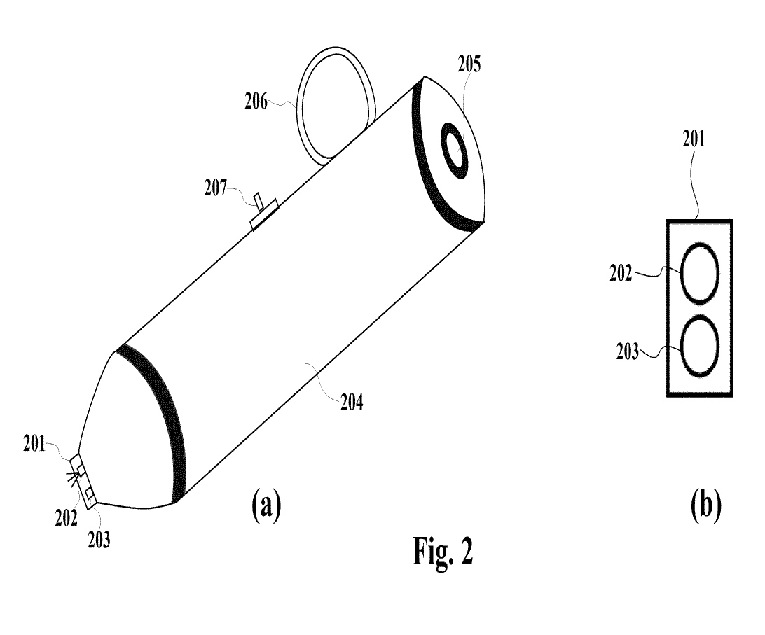

FIG. 2(a) presents a structure of the pen-shaped active sensing body. The tip 201 of the pen-shaped body contains the sensor unit mentioned above. Consequently, at the tip 201 of the pen-shaped body, there is a Coupling unit consisting of a light source 202 and a light sensor 203. The front-view of the tip of pen-shaped body is shown in FIG. 2(b). Here, the tip 201 is rectangular in shape. Besides, the Computational unit and the Output unit are placed inside the body 204. A 3.5 mm audio socket 205 is connected with the Computational unit and placed at the back of the pen-shaped body. An earphone or a headphone jack can be easily plugged into the socket 205 to hear the sound generated by the Output unit. Alongside, a battery holder 206 for operating with an energy source consisting a coin-cell battery is placed over the pen-shaped body. Nonetheless, a switch 207 is used to turn on/off the whole sensing body.

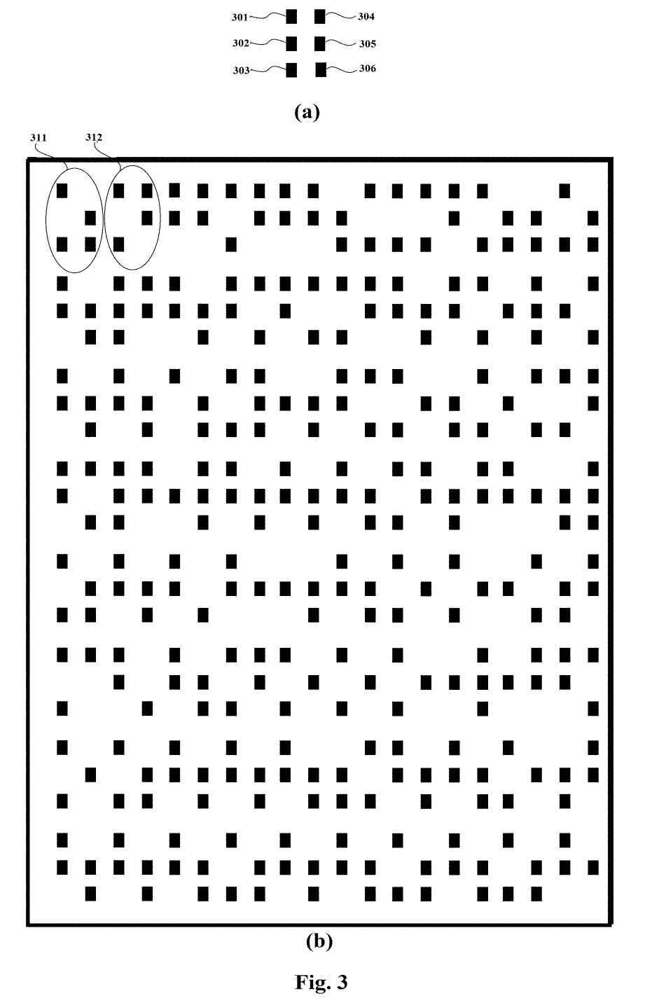

FIG. 3(a) shows all six dots allowable for a Braille character. Here, a Braille character contains two columns having 3 dots in each column. The numbering of the dots of a Braille character is started from the left top 301 and that dot is marked as “1”. Then, the numbering goes downward along the column. The second dot 302 in the left column is marked as “2” and third one 303 as “3”. Again, the topmost dot of right column 304 is marked as “4”, and the next two dots 305 and 306 of right column are marked as “5” and “6” respectively.

FIG. 3(b) shows Braille characters worth of being printed on an A4 size paper using conventional ink-jet or leaser printers. Here, the background color is chosen to be white and the color of the dots of Braille characters is chosen to be of black. This color combination can be changed. In FIG. 3(b), there are eight lines each line consisting of ten Braille characters. These number of lines and number of Braille characters per line can be varied with the size of the tip of pen-shaped body and the size of page being printed. The first Braille character 311 contains dots 1, 3, 5, and 6, which generally represents “Z”. Again, the second Braille character 312 contains dots 1, 2, 4, and 5, which generally represents “G”.

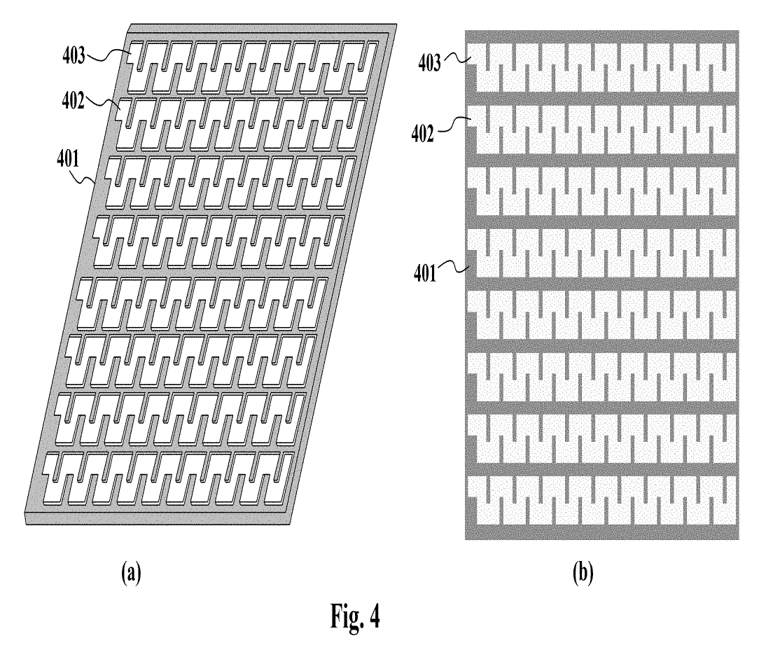

FIG. 4 shows the structure of a trajectory guide board 401. FIG. 4(a) presents the 3D view and FIG. 4(b) presents the top view of the board. The board can be made of any solid material and can be of any size according to the size of the selected paper. The board presented in FIG. 4 is made of plastic and is of A4 size. A trajectory is made on the board to help and guide visually-impaired people in reading printed Braille characters on a paper (FIG. 3(b)). A trajectory is made by drilling a hole 402 through top to bottom faces along the thickness of the board 401. The hole 402 is shaped in such a way that it fits the tip 201 of the pen-shaped body. A paper with printed Braille characters, such as shown in FIG. 3(b), is attached beneath the trajectory guide board. The trajectory on board defines the path of movement of the tip over the attached paper containing printed Braille characters. Here, at first, the tip of pen-shaped body is placed at the leftmost top corner 403 of the board and then it glides on the board following the drilled trajectory. The path of trajectory is defined in such a way that the dot(s) of a printed Braille character appear in certain position(s) on the path. The path guides to identify several Braille characters along a line. The path is repeated in a similar manner for identifying Braille characters printed in different lines.

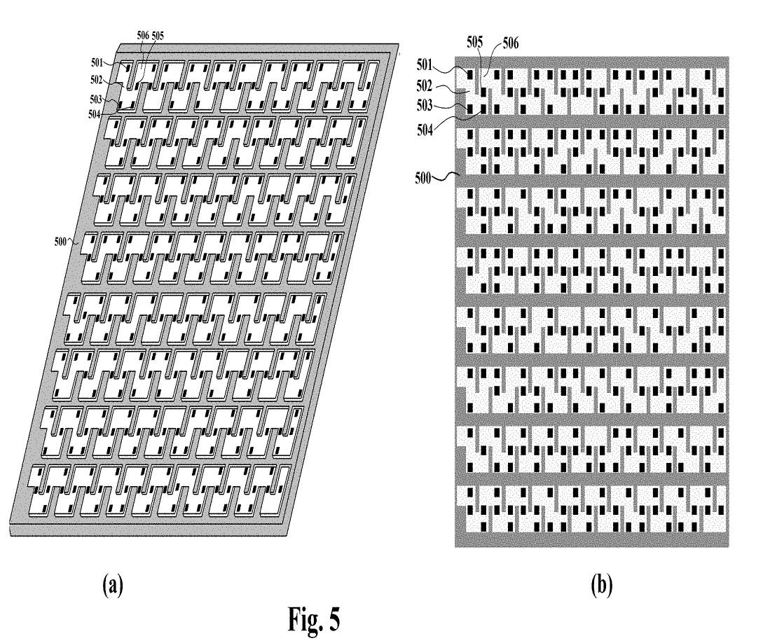

FIG. 5 shows a trajectory guide board attached over a paper containing printed Braille characters and demonstrates the methodology of reading those Braille characters. FIG. 5(a) presents a 3D view and FIG. 5(b) presents a top view. A paper with printed Braille characters (as shown in FIG. 3(b)) is attached beneath the trajectory guide board 500 (as shown in FIG. 4). During the reading operation, first, a visually-impaired person places tip of pen-shaped body at the leftmost top corner of the board 500. Then, the tip is glided towards the adjacent right point 501 following the trajectory. Note that the point 501 is the top point of the first vertical part of the trajectory. When the tip reaches the point 501, the Computational unit detects a black dot through processing the signal generated by the sensor 203 and generates a sound using the Output unit 104. The visually-impaired person hears the sound and recognizes the presence of dot “1” in the first Braille character. Then, the tip is glided down following the trajectory and reaches at the middle point of the first vertical part of the trajectory, i.e., the point 502. However, as there is no dot at 502, the Output unit generates no sound. Thus, the visually-impaired person recognizes the absence of dot “2” in the first Braille character. Then, the tip is continued to glide down following the trajectory and reaches at the bottom point of the first vertical part of the trajectory, i.e., the point 503. Here, the point 503 contains a dot and the output unit generates a sound accordingly. Thus, the visually-impaired person recognizes the presence of dot “3” in the first Braille character. Next, the tip is glided towards right following the trajectory and reaches at point 504, which is the bottom point of the second vertical part of the trajectory. As the point 504 contains a dot, the Output unit generates a sound here. Thus, the visually-impaired person recognizes the presence of dot “6” in the first Braille character. Then, the tip is glided up following the trajectory and reaches at point 505, which is the middle point of the second vertical part of the trajectory. Here, the point 505 contains a dot and the Output unit generates a sound accordingly. Thus, the visually-impaired person recognizes the presence of dot “5” in the first Braille character. Next, the tip is glided up again following the trajectory and reaches at point 506, which is the topmost point of the second vertical part of the trajectory. However, as there is no dot at 506, the Output unit generates no sound. Thus, the visually-impaired person recognizes the absence of dot “4” in the first Braille character. As a whole, the visually-impaired person understands that the first Braille character contains dot 1, 3, 5, and 6, and thus, (s)he identifies the character as “Z”. Note that, for recognizing the first Braille character through scanning all six relative positions, the points 501, 502, 503, 504, 505, and 506 are followed in sequence by the tip of the pen-shaped body. Following the same procedure of recognizing dots of a Braille character through scanning all six relative positions of a Braille character using the pen-shaped body, the visually-impaired person can continue reading subsequent Braille characters. To do so, the tip is glided towards right from the point 506 to read out subsequent Braille characters.

The trajectory guide board helps in writing Braille characters in the same way that it helps one in reading. Here, a visually-impaired person uses a regular marker pen (can be of black in color) instead of the pen-shaped body. For writing, the visually-impaired person puts Braille dot(s) at the desired relative position(s) of the paper through the hole of trajectory guide board using the marker pen. Subsequently, the visually-impaired person can go back and read the written Braille characters through using the pen-shaped body.

Nevertheless, it is possible to perceive a geometric shape through detecting locus of the geometric shape printed on the paper. The trajectory guide board is not needed here. Instead, as the border of the geometric shape appears in black color, the geometric shape can be understood by recognizing the locus of the geometric shape through perceiving sound generated by the Output unit.

What is claimed is:

1) A system comprising:
an active sensing body;
a coupling of light source and light sensor positioned at the tip of the sensing body;
light source continuously radiates energy over the visible light spectrum;
each light sensor generates signal according to illuminance of the light incident upon it, after the light being reflected from a surface containing printed region(s);
a processing unit inside the sensing body, connected with coupling, detects the presence of printed region(s) having distinct color on the surface through comparing signal value(s) with predefined threshold value;
the processing unit generates output(s) according to detected printed region of distinct color.

2) The system as recited in claim 1, wherein the output generated by the processing unit can be any signal that could be perceived such as audio, pressure, vibration, etc.

3) The system as recited in claim 1, wherein the colored region(s) can be of any color.

4) The system as recited in claim 1, wherein a printed region of distinct color can represent any distinctive feature such as a Braille dot, border of a geometric shape, etc.

5) The system as recited in claim 4, wherein the Braille dot can be of any shape such as square, rectangle, circle, etc.

6) The system as recited in claim 1, wherein the tip of the active sensing body can be of any shape such as square, rectangle, circle, etc.

7) The system as recited in claim 1, further comprising:
a trajectory guide board, which is attached over the surface containing printed region(s) and the trajectory is made by drilling holes through top to bottom along the thickness of a solid board such as a plastic board, an ebonite board, etc.

8) The system as recited in claim 7, wherein the space provided through the holes drilled in the trajectory guide board fits the size of the tip of the active sensing body such that the tip can glide through the drilled holes.

9) The system as recited in claim 7, wherein the trajectory guide board defines the path of movement of the tip of the active sensing body over the printed surface.

10) The system as recited in claim 9, wherein the path of movement is defined in such a way that any number of dots having predefined relative positions can appear over the path.

11) The system as recited in claim 9, wherein the path of movement is defined in such a way that the potential six dots of a printed conventional Braille character remain at certain relative positions over a straight line path of movement.

12) The system as recited in claim 11, wherein the path of movement can be repeated in a similar manner for multiple Braille characters.

13) The system as recited in claim 12, wherein a blind or visually-impaired person perceives a Braille character by detecting the relative position(s) of the printed Braille dot(s) through sensing the perceivable output signal(s) generated by the system.

14) The system as recited in 4, wherein a blind or visually-impaired person perceives geometric shape(s) by detecting the locus of the printed geometric shape(s) through sensing the perceivable output signal(s) generated by the system.

15) The system as recited in claim 14, wherein the geometric shape can be any predefined shape such as line, circle, polygon, etc.
